(19) United States
(12) Patent Application Publication
(10) Pub. No.: US 2015/0229183 A1
(43) Pub. Date: Aug. 13, 2015

(54) Bicycle Generator Having a USB Port

(71) Applicant: Michael Mohamed Waheed, St. Petersburg, FL (US)

(72) Inventor: Michael Mohamed Waheed, St. Petersburg, FL (US)

(21) Appl. No.: 14/178,574

(22) Filed: Feb. 12, 2014

(51) Int. Cl. H02K 7/18; B62J 6/00

(52) U.S. Cl. CPC H02K 7/1846; B62J 6/003

(57) ABSTRACT

A bicycle generator having a housing with a rotatable end located opposite a USB port. The rotatable end of the housing is adapted to connect to the sidewall of a tire or a rim. The USB port is adapted to receive to a USB cable connected to a light emitting unit or a mobile phone. The mounting bracket has a capturing surface adapted to receive the housing and another capturing surface adapted to receive a portion of the bicycle, whereby, orienting the rotatable end of the housing to contact a sidewall of the tire or rim. The tire rotation causes the rotatable end of the housing to rotate the generator which causes the generator to produce a current. The current is in electrical communication with the USB port.

### BACKGROUND OF THE INVENTION

1. Field of the Invention

This invention relates, generally, to a manually operated battery charging device. More particularly, it relates to a generator rotatably mounted to the structure of a bicycle and having a USB port.

2. Background Art

In some parts of the world, electricity may not be available to use during certain times of the day. Often in third world countries, many individuals go without electricity for extended periods of time and many individuals do not have access to electricity. When travelers visit these areas having restricted or unavailable electricity access, they are faced with the problem of not being able to charge their mobile devices. There is a need to provide individuals with a convenient source of electricity that is both affordable and portable to allow for a mobile device to be charged.

Currently, large generators can be used as a source of electricity. However, they are bulky and heavy. These large generators are not easily portable due to their heavy weight. They also need gasoline to power them. Thus, there is a need for a light weight and easily portable source of electricity.

When riding a bicycle, many individuals rely on their mobile phones for GPS guidance, to make emergency calls, or to listen to music. When traveling long distances, a mobile phone can become depleted of battery power, thereby, rendering the mobile device inoperable. Thus, there is a need for a portable charging device sufficient enough to charge a mobile device while a user is operating a bicycle or a motorcycle.

More particularly, individuals talk on their mobile phone, watch movies from their mobile phone, or listen to music from their mobile phone while on exercise equipment including, bicycles. There is a need for a battery charging device that can be mounted on the exercise device to enable a mobile phone to be charged.

Additionally, it can be hazardous for a bicyclist's safety when a user is riding a bicycle when it is dark outside. Battery powered lights loose battery power quickly and are not reliable when in use for long periods of time. Thus, there is a need for a light emitting unit that does not require the use of battery power when a user is operating a bicycle.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a bicycle generator including a housing having an end that is rotatably mounted to a portion of a bicycle and an opposite end having a USB port which also includes improvements that overcome the limitations of prior art mobile device chargers is now met by a new, useful, and non-obvious invention.

The novel charging device has a generator capable of being mounted onto the structure of including, but not limited to, a bicycle, a motorcycle, or any other system capable of rotating a portion of a generator. The generator has a housing having an end with a rotatable portion located opposite an end having a USB port. The bicycle generator housing has a top portion with a diameter substantially smaller than the diameter of the lower portion. The end having the rotatable portion is adapted to come into contact with the sidewall of a tire or a rim. When the tire is rotated from a user pedaling a bicycle, the rotatable portion of the generator produces a current being in electrical communication with the USB port. The USB port receives an end of a USB cable. The opposite end of the USB cable is connected to including, but not limited to, a light emitting unit or a mobile phone.

In a preferred embodiment, the bicycle generator is mounted to a bicycle structure with a clamp. The clamp has a portion that receives the generator and another portion that receives a portion of the bicycle frame. The clamp connects to the perimeter of the lower portion of the generator housing.

In a second embodiment, the novel bicycle generator has a USB port located on preferably the bottom portion of the generator. When the USB port is located on the bottom portion of the generator, rain and other debris are less likely to enter the USB port. It is also within the scope of this invention for the USB port to be located on any surface of the generator and to have a cover to seal the USB port from foreign debris including, but not limited to, water, dirt, or rocks when not in use.

It is therefore an important object of the present invention to provide a portable, small sized bicycle generator having a USB port that is adapted to receive a USB cable. The USB cable is capable of connecting a cell phone or a light to the USB port of the generator.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of the novel bicycle generator and clamp;

FIG. 2 is a perspective view of the novel bicycle generator mounted onto the frame of a bicycle; and,

FIG. 3 is an exploded view of the novel bicycle generator mounted onto a bicycle.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In a general embodiment the novel bicycle generator has a housing having a rotatable end located opposite a USB port. It is within the scope of this invention for the generator to connect to a motorcycle as well. The rotatable end of the housing is adapted to connect to the sidewall of a tire. It is also within the scope of this invention for the rotatable end of the housing to be adapted to connect to the sidewall of a rim. The USB port is adapted to connect to a USB cable. The mounting bracket has a capturing surface adapted to receive the generator housing and another capturing surface adapted to receive a portion of a bicycle, whereby orienting the rotatable end to contact a sidewall of the tire. The tire rotation causes the rotatable end to rotate the generator which causes the generator to produce a current. The current is in electrical communication with the USB port.

In a preferred embodiment, the USB port receives a USB cable connected to including but not limited to, a light emitting unit or a mobile phone.

### Construction of the Novel Bicycle Generator

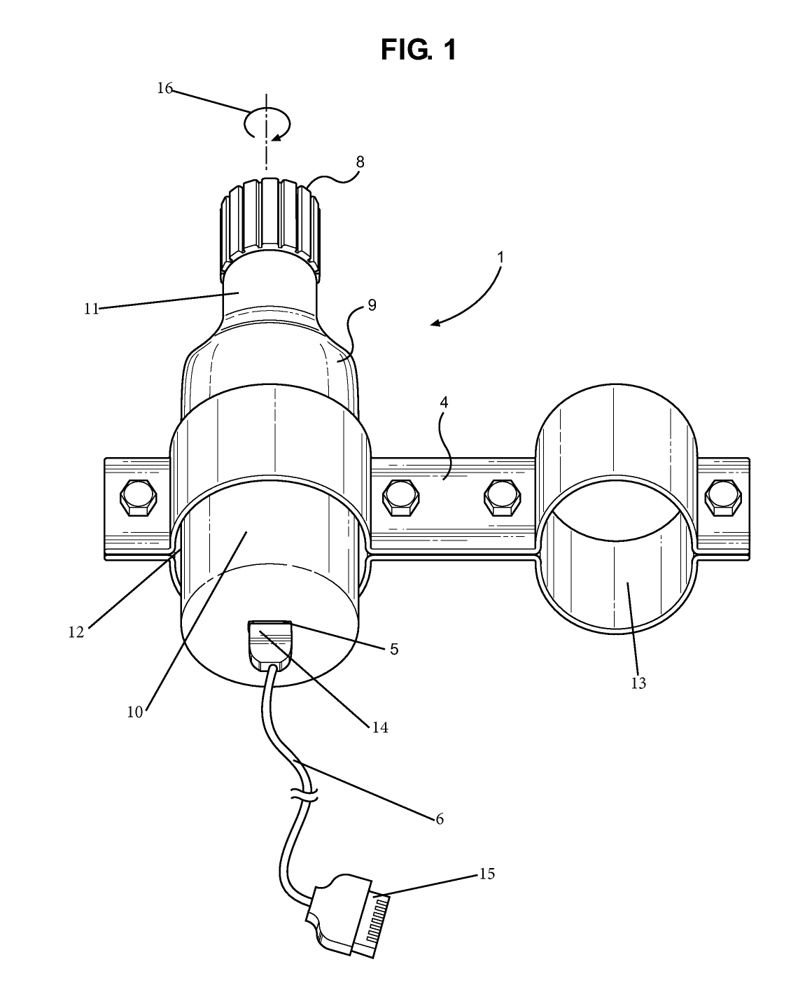

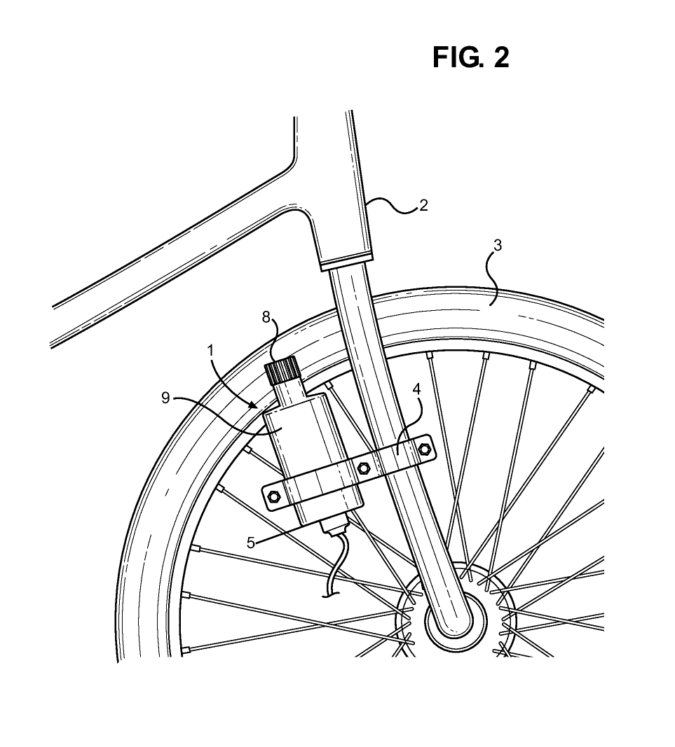

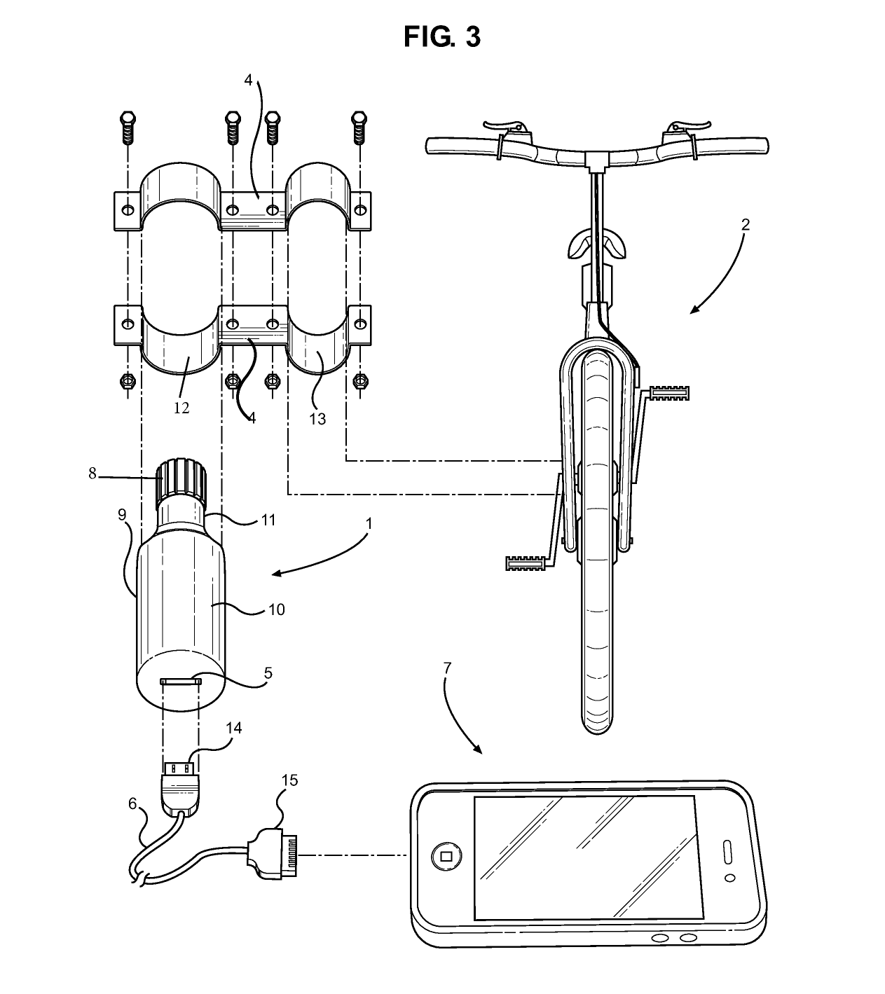

It will now be seen, referring to FIGS. 1-3, the novel bicycle generator 1 includes housing 9 having rotatable portion 8 located opposite an end having USB port 5. Mounting bracket 4 secures housing 9 to a portion of bicycle 2 (FIGS. 2 and 3). FIG. 2 illustrates rotatable 16 (FIG. 1) portion 8 in contact with a sidewall of tire 3. FIGS. 1 and 3 depict USB cord 6 having end 14 connecting to USB port 5 of generator 1 and end 15 connecting to a portion of mobile phone 7 (FIG. 3). As best shown in FIGS. 1 and 3, clamp 4 has portion 12 that receives generator housing lower portion 10 and another portion 13 that receives a portion of the bicycle frame 2 (FIG. 3). Bicycle generator housing 9 has top portion 11 with a diameter substantially smaller than the diameter of generator housing lower portion 10.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. An bicycle generator, comprising:
a housing, said housing having a rotatable end located opposite a USB port;
said rotatable end adapted to contact a sidewall of a tire;
said USB port adapted to connect to an end of a USB cable;
a mounting bracket, said mounting bracket having a first capturing surface and a second capturing surface;
said first capturing surface adapted to receive said housing, said second capturing surface adapted to receive a portion of said bicycle, whereby, said rotatable end of said housing is oriented to contact said sidewall of said tire, whereby, the tire rotation causing said rotatable end to rotate said generator, whereby, said generator producing a current, said current being in electrical communication with said USB port.

2. The bicycle generator of claim 1, wherein a light emitting unit is connected to an end of said USB cable.

3. The bicycle generator of claim 1, wherein a mobile phone is connected to an end of said USB cable.

4. An motorcycle generator, comprising:
a housing, said housing having a rotatable end located opposite a USB port;
said rotatable end adapted to contact a sidewall of a tire;
said USB port adapted to connect to an end of a USB cable;
a mounting bracket, said mounting bracket having a first capturing surface and a second capturing surface;
said first capturing surface adapted to receive said housing, said second capturing surface adapted to receive a portion of said motorcycle, whereby, said rotatable end of said housing is oriented to contact said sidewall of said tire, whereby, the tire rotation causing said rotatable end to rotate said generator, whereby, said generator producing a current, said current being in electrical communication with said USB port.

5. The bicycle generator of claim 4, wherein a light emitting unit is connected to an end of said USB cable.

6. The bicycle generator of claim 4, wherein a mobile phone is connected to an end of said USB cable.

7. An bicycle generator, comprising:
a housing, said housing having a rotatable end located opposite a USB port;
said rotatable end adapted to contact a sidewall of a rim;
said USB port adapted to connect to an end of a USB cable;
a mounting bracket, said mounting bracket having a first capturing surface and a second capturing surface;
said first capturing surface adapted to receive said housing, said second capturing surface adapted to receive a portion of said bicycle, whereby, said rotatable end of said housing is oriented to contact said sidewall of said rim, whereby, the tire rotation causing said rotatable end to rotate said generator, whereby, said generator producing a current, said current being in electrical communication with said USB port.

8. The bicycle generator of claim 7, wherein a light emitting unit is connected to an end of said USB cable.

9. The bicycle generator of claim 7, wherein a mobile phone is connected to an end of said USB cable.
